(19) United States
(12) Patent Application Publication
(10) Pub. No.: US 2020/0312549 A1
(43) Pub. Date: Oct. 1, 2020

(54) CAPACITOR TRAY

(71) Applicant: Moog Unna GmbH, Unna (DE)

(72) Inventors: Ray Opie, Orchard Park, NY (US); Michael Willers, Killeagh (IE); Frederik Hermsen, Unna (DE)

(21) Appl. No.: 16/098,779

(22) PCT Filed: May 2, 2017
(86) PCT No.: PCT/EP2017/060418

§ 371 Date: Nov. 2, 2018

Related U.S. Application Data
(60) Provisional application No. 62/331,239, filed on May 3, 2016.

(30) Foreign Application Priority Data
Jun. 2, 2016 (GB) 1609688.5

(51) Int. Cl. H01G 2/06; H01G 11/12; H01G 11/82; H01G 4/38

(52) U.S. Cl. CPC H01G 2/06; H01G 4/38; H01G 11/82; H01G 11/12

(57) ABSTRACT

An energy storage assembly of capacitors (10) in a housing which is attached to a mounting surface (2). The mounting surface could be the inner surface of the rotary part (hub, (1)) of a wind turbine. The energy storage assembly being characterized in that it comprises a resiliently compressible material (40) situated between the energy storage element (capacitor) and a mounting surface. The resiliently compressible material serves to prevent damage to the energy storage caused by the movement of the wind turbine. The energy storage assembly acting as an emergency power supply for a pitch control mechanism of a wind turbine.

### FIELD OF INVENTION

The invention relates to improvements in low-stress electrical component mountings. Particularly, but not exclusively, it relates to the mounting of capacitors in a rotating hub of a wind turbine, wherein said capacitors serve as an emergency power supply for the pitch control mechanism of the turbine rotor blades.

### BACKGROUND TO THE INVENTION

Wind turbines having rotor blades mounted on a rotor may use pivotable rotor blades for limiting the rotational speed of the turbine in order to prevent structural damage when strong winds occur, or to stop rotation completely. By angling the rotor blade into or out of the wind, the rotational torque experienced by the rotor blades is controlled, and the rotation speed and the generated power of the wind turbine can be adjusted and maintained within operational limits.

In situations where it is critical that the rotors be stopped or have their speed otherwise limited, such as when the wind turbine is approaching overload or a structural safety threshold, it is critical that the pitch control mechanisms are functional at least for a time period that is necessary to turn all rotor blades into a so-called feathering position, where the rotor blades will bring the rotor to a halt. Accordingly, it has become standard practice to provide pitch control mechanisms with emergency backup power supplies, such that the wind turbine can reduce rotor speed even in the event of a power loss or other failure.

An emergency power supply is often provided in the form of one or more energy storage devices which are installed within the rotating hub of the wind turbine, close by the pitch control motors located at the base of each rotor blade.

Most current implementations utilize capacitors as the energy storage device. These are mounted on printed circuit boards (PCBs) which are subject to shock, vibration or gravity induced bending. As capacitors are thin shelled cylinders, they are inherently not mechanically robust. Further, given the capacitor module is usually made up of many capacitors in series, the failure of a single capacitor renders the module useless. As the module is a key energy source in the safety system of a wind turbine, these failures have severe implications, including injury, turbine collapse to loss of life.

The current approach to this problem is to support the PCBs, and sometimes the capacitors themselves, by rigidly affixing them to the inside of the hub of the wind turbine.

The mechanical supports of current designs do not fully support the capacitors in a low stress manner. There are stress concentrations created either by hard fixing components or by the rotation of the assembly in the hub. One potential solution is to provide complete redundancy, but this creates two other issues. The first is that the overall pitch system reliability is reduced, meaning that increased time that the turbine cannot generate power. The second is cost. Capacitor technology is one of the most expensive assemblies within a pitch system. Thus the invented solution enables cost reduction within the pitch system.

An object of the present invention is to mitigate some of the deficiencies of the prior art mentioned above.

### SUMMARY OF THE INVENTION

In accordance to an aspect of the invention, there is provided an energy storage assembly comprising a first layer, wherein the first layer comprises an energy storage device situated on a mounting surface, and a resiliently compressible material situated between the energy storage device and the mounting surface.

By providing a resiliently compressible material between the energy storage device and the mounting surface, any forces applied to the energy storage assembly are evenly distributed across the entire assembly, which prevents any localised mechanical forces or stresses, whatever their cause (gravity, rotation, shock, vibration and thermal expansion), from causing damage to the components within, including the energy storage device. Moreover, the compressible nature of the material allows for variations in mechanical height of the layer components to be accommodated.

Preferably, the first layer further comprises a printed circuit board, wherein the energy storage device is mounted on the printed circuit board, and the printed circuit board is attached to the resiliently compressible material. The use of a printed circuit board allows for simplified installation of the energy storage device within the energy storage assembly. It further acts as a base for attaching the energy storage device to the resiliently compressible material by which it is mounted to the mounting surface.

Preferably, the printed circuit board is contacted to the resiliently compressible material by one of compression forces alone, a mechanical fixing, or chemical adhesive. Securing the printed circuit board by compression forces alone (including gravitational forces, centrifugal forces or forces exerted by a housing around the energy storage assembly) allows for a reduction in the total number of component parts within the energy storage assembly, saving weight and cost and simplifying maintenance.

Preferably, the first layer further comprises a second resiliently compressible material such that the energy storage device is between the first and second resiliently compressible materials. This second layer enables the energy storage assembly to absorb greater forces, further cushioning the more delicate components and preventing damage.

Preferably, the energy storage device is a capacitor. Alternatively, the skilled person would be aware that the energy storage device may be a battery or other suitable form of long term energy storage.

Preferably, the capacitor is a bank of capacitors. Providing further capacitors allows for an increased energy storage capability as well as component redundancy and increased utilization of space in the hub.

Preferably, the capacitors of the capacitor bank are connected in series. This allows for the energy storage assembly to have a large working voltage.

Preferably, this resiliently compressible material is foam rubber or silicone. Both foam rubber and silicone are robust, thermally and electrically insulating and low cost.

Alternatively, this resiliently compressible material is one or more mechanical spring. This mechanical spring may be used in conjunction with one or more rigid mounting plates located between the spring and one or both of the mounting surface and the printed circuit board. Springs are low cost, light weight and can be easily tuned to balance the forces experienced by the energy storage assembly.

Preferably, the energy storage assembly further comprises a second layer, wherein the second layer is stacked on top of the first layer, such that the resiliently compressible material of the second layer is situated between the printed circuit board of the second layer and the energy storage device of the first layer.

By providing an energy storage assembly with stackable layers, additional components can be added whilst not enlarging the footprint of the assembly on the mounting surface. This allows for a more efficient use of space. Further, by providing additional layers of resiliently compressive material, the amount of force capable of being absorbed by the assembly is increased.

Preferably, the second layer is identical to the first layer. This allows for ease of installation, as well as equal and balanced weight distribution within the energy storage assembly.

Preferably, the energy storage assembly comprises three layers. There is no strict limit to the number of layers that can be included within the energy storage assembly other than the available space and the strength of the mounting surface.

Preferably, the energy storage assembly is situated in a housing, whereby the housing is attached to the mounting surface. The housing provides further physical protection to the energy storage assembly and may enclose the assembly on all sides, or cover one or more of the sides of the assembly not in contact with the mounting surface. The housing may be unitary or formed from multiple component parts. In addition, the housing may act as both a thermal and electrical insulator, to act as a shield against any detrimental external conditions on the energy storage assembly. Moreover, the housing may act to constrain the dimensions of the energy storage assembly such that the resiliently compressible material is pre-stressed. The pre-stressed resiliently compressible material thus exerts a force on the remaining components of the energy storage assembly. This force allows the energy storage assembly to be braced inside the housing, protecting it from damage independently of any other external or internal forces.

Preferably, the housing acts to pre-compress the resiliently compressible material. This serves to provide mechanical stiffness in all three possible axis of rotation, commonly labelled X, Y and Z to hold the energy storage assembly in a fixed position inside the housing. Increasing its protection from damage which may otherwise result from movement of the energy storage assembly inside the housing.

Preferably, the pre-compression alone results in a force being exerted on the energy storage assembly in excess of twice the gravitational force acting on the energy storage assembly. In the case that the mounting surface rotates about an axis and a centripetal force acts on the energy storage assembly, the assembly will only experience positive acceleration (g's), rather than oscillating between positive and negative g's as would otherwise be the case. By fitting the housing around the energy storage assembly such that the dominant force experienced by the assembly during any form of movement of the housing or mounting surface is the pre-compression exerted by the housing and the resiliently flexible material, the assembly is effectively decoupled from both the housing and the mounting surface and is therefore protected from external forces or accelerations which may otherwise result in mechanical stress or damage to the assembly.

Preferably, the housing further comprises one or more rods extending through the energy storage assembly, perpendicular to the layers of the energy storage assembly. This rods acts a structural support and aids with the alignment of the layers within the energy storage assembly, reducing the likelihood of mis-installation and ensuring the layers are in the desired plane relative to the mounting surface, which allows for maximum utilisation of the resiliently compressible material.

Preferably, the opposite ends of the one or more rods are connected to opposite sides of the housing. This allows the rods to strengthen the housing as well as to transfer any deliberate and desired compressive forces from the housing to the energy storage assembly.

Preferably, the one or more rods pass through corresponding holes in the printed circuit board of each layer of the energy storage assembly, with a resiliently compressible material suited between the edges of the one or more rods and the corresponding holes. This allows for some relative lateral movement between the layers of the energy storage assembly and the housing, as well as the layers themselves, such that the assembly is not entirely rigid and therefore brittle. The provision of the resiliently compressible material between the layers of the assembly allows for any excess lateral movement to be damped, preventing damage to the energy storage assembly.

Preferably, the housing further comprises sleeves around the portions of the one or more rods which protrude from the printed circuit board of each layer of the energy storage assembly. These sleeves act as rigid supports between the layers of the energy storage assembly, preventing any change in the relative spacing of the stacked layers and the associated imbalance of compressive forces experienced by the energy storage assembly.

The enclosing housing plays a key role in order to guarantee the pre-compression force and also the friction that limits the movement of the printed circuit boards, especially during any form of rotation motion of the energy storage assembly. The housing renders the energy storage assembly independent from any mounting location, i.e. any motion of the assembly (even damped motion) is localised within the housing. Accordingly, the assembly does not exert a force on the mounting surface or any other components in the vicinity of the assembly.

Preferably, the mounting surface is the inner surface a rotating body. As the mounting surface spins about the axis of rotation, a centrifugal force is produced which effectively acts to compress the energy storage assembly in a direction tangential to the axis of rotation (i.e. into the mounting surface). The energy storage assembly is arranged such that the resiliently compressible material is able to absorb this compressive force, preventing the other components of the energy storage assembly from being crushed. Accordingly, the energy storage assembly can be located inside the rotating body without risking damage to itself or any other components. In addition, the resiliently compressible material can be selected so as to absorb enough force to prevent damage to the energy storage device whilst transferring enough force such that the components are held in place during rotation, preventing damage that may result from movement of the energy storage assembly itself or the relative movement of the components within.

Preferably, one or more additional energy storage assemblies are radially disposed about the axis of rotation of the rotating body. Providing further energy storage assemblies increases the total amount of energy storage. Further, radially distributing the energy storage assemblies about the axis of rotation of the hub allows for the hub to be balanced, whilst allowing each assembly to experience the same centrifugal force.

Preferably, the rotating body is the hub of a wind turbine and mounting surface is the inner surface the of the hub shell. This allows for the energy storage assembly to be attached directly to the inside of the hub superstructure. Maximising the use of space within the hub, and preventing the need for additional mounting surfaces which may otherwise add weight or complexity to the wind turbine.

Preferably, the energy storage assembly acts as an emergency power supply for a pitch control mechanism of the wind turbine rotor blades. By providing the power supply in close proximity to the rotor blade pitch motors, electrical losses associated with excess cabling are minimised.

Other aspects of the invention will be apparent from the appended claim set.

### BRIEF DESCRIPTION OF THE DRAWINGS

Embodiments of the present invention will now be described, by way of example only, with reference to the accompanying drawings, in which:

FIG. 1 is a schematic of a single layer energy storage assembly in accordance with an embodiment of the invention.

FIG. 2 is a schematic of a single layer energy storage assembly in accordance with an embodiment of the invention.

FIG. 3 is a schematic of a multi-layer energy storage assembly in accordance with an embodiment of the invention.

FIG. 4 is a simplified schematic of an energy storage assembly in accordance with an embodiment of the invention.

FIG. 5 is a simplified schematic of an energy storage assembly in accordance with an embodiment of the invention.

FIG. 6 is a schematic of a wind turbine hub in accordance with an embodiment of the invention.

FIG. 7 is a perspective view of a housing in accordance with an embodiment of the invention.

FIG. 8 is a cut away view of an energy storage assembly in accordance with an embodiment of the invention.

FIG. 9 is a perspective view of a portion of the housing in accordance with an embodiment of the invention.

FIG. 10 is a perspective view of a portion of the housing in accordance with an embodiment of the invention.

FIG. 11 is a simplified schematic of a partially assembled energy storage assembly in accordance with an embodiment of the invention.

FIG. 12 is a simplified schematic of an energy storage assembly in accordance with an embodiment of the invention.

FIG. 13 is a simplified schematic of an energy storage assembly in accordance with an embodiment of the invention.

FIG. 14 is a simplified schematic of an energy storage assembly in accordance with an embodiment of the invention.

FIG. 15 is a perspective view of a housing in accordance with an embodiment of the invention.

FIG. 16 is a cut away view of an energy storage assembly in accordance with an embodiment of the invention.

FIG. 17 is a simplified schematic of an energy storage assembly in accordance with an embodiment of the invention.

FIG. 18 is a simplified schematic of an energy storage assembly in accordance with an embodiment of the invention.

FIG. 19 is a simplified schematic of a spacer layer in accordance with an embodiment of the invention.

### DETAILED DESCRIPTION OF AN EMBODIMENT

In order to provide a secure yet low stress mounting for an energy storage device on a mounting surface, there is provided an energy storage assembly in accordance with the present invention.

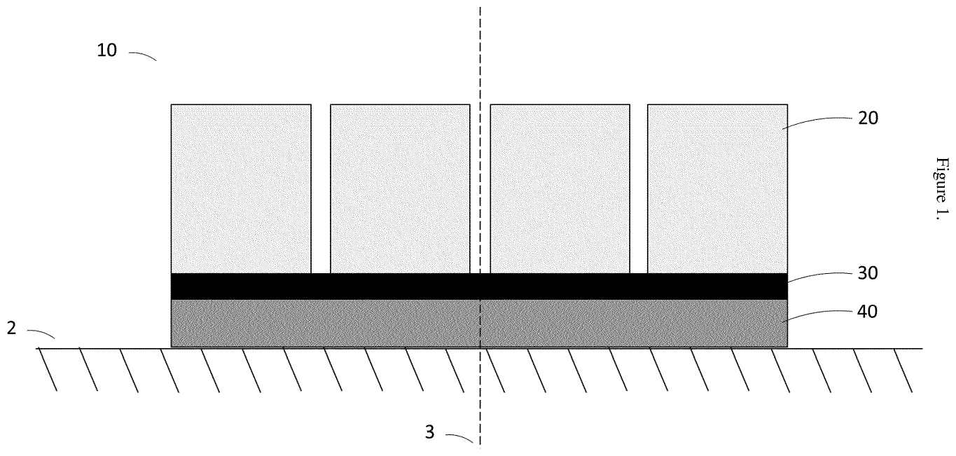

FIG. 1 shows a schematic of an energy storage assembly 10 mounted on to a mounting surface 2. The energy storage assembly 10 comprises at least an energy storage device 20, and a resiliently compressible material 40, wherein the resiliently compressible material 40 is situated between the energy storage device 20 and the mounting surface 2.

The energy storage assembly 10 is mounted such that the layers of the assembly 10 are tangential to the mounting surface 2.

In an embodiment, the energy storage device 20 is a conventional capacitor and operates in a known manner. It may also be a battery or any other suitable energy storage device.

In a preferred embodiment, the energy storage device 20 is a bank of electronically connected capacitors. In a further embodiment, the energy storage device 20 is part of the emergency power supply for the pitch control mechanism of one or more of the wind turbine rotor blades.

The resiliently compressible material 40 is situated between the energy storage device 20 and the mounting surface 2. In an embodiment, the resiliently compressible material 40 is a sheet of foam rubber sheet or silicone. In an alternative embodiment, the resiliently compressible material 40 is one or more mechanical springs. As such, any known suitable resiliently compressible material can be employed. It would be apparent to the skilled person, within the context of the invention that the term resiliently compressible relates to a deformable material that will return to its original form when any compression forces are removed.

Optionally, the energy storage assembly 10 comprises a printed circuit board (PCB) 30 on which the energy storage device 20 is mounted directly, the PCB 30 situated between the energy storage device 20 and the resiliently compressible material 40 and occupies a plane tangential to the mounting surface 2.

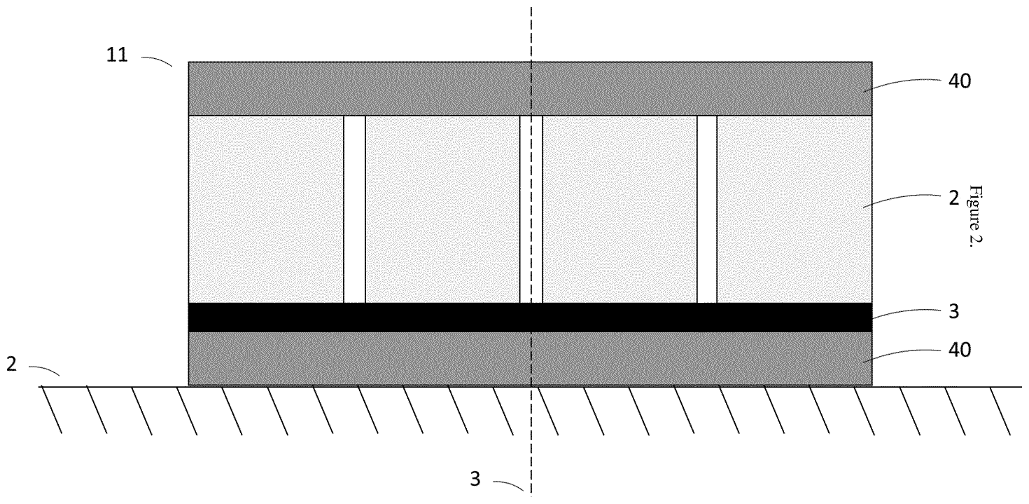

Optionally, the energy storage assembly 10 comprises an additional resiliently compressible material 40 such that the energy storage device 20 is situated between the two resiliently compressible materials 40 which form the outer most components of the energy storage assembly 10, as shown in FIG. 2.

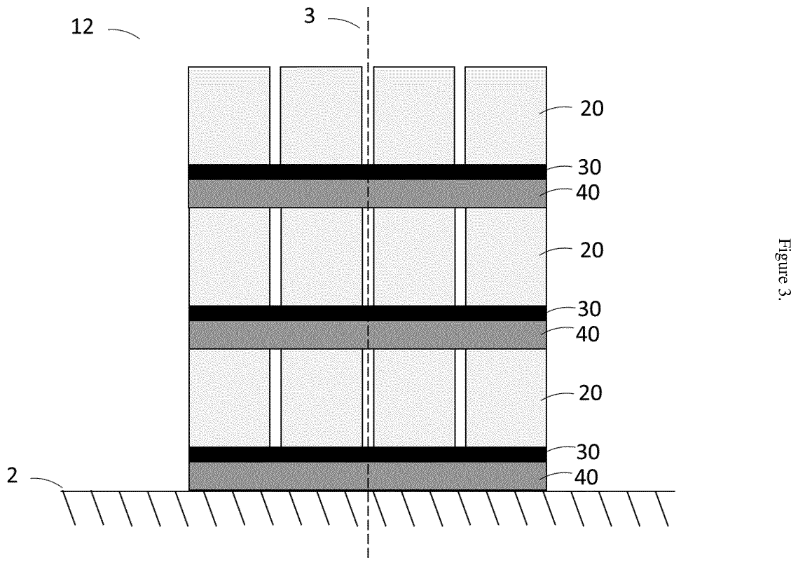

Optionally, the energy storage assembly 10 comprises additional alternating parallel layers of energy storage devices 20, PCBs 30 and resiliently compressible material 40, as depicted by FIG. 3, with each layer being parallel to each other and tangent to the mounting surface.

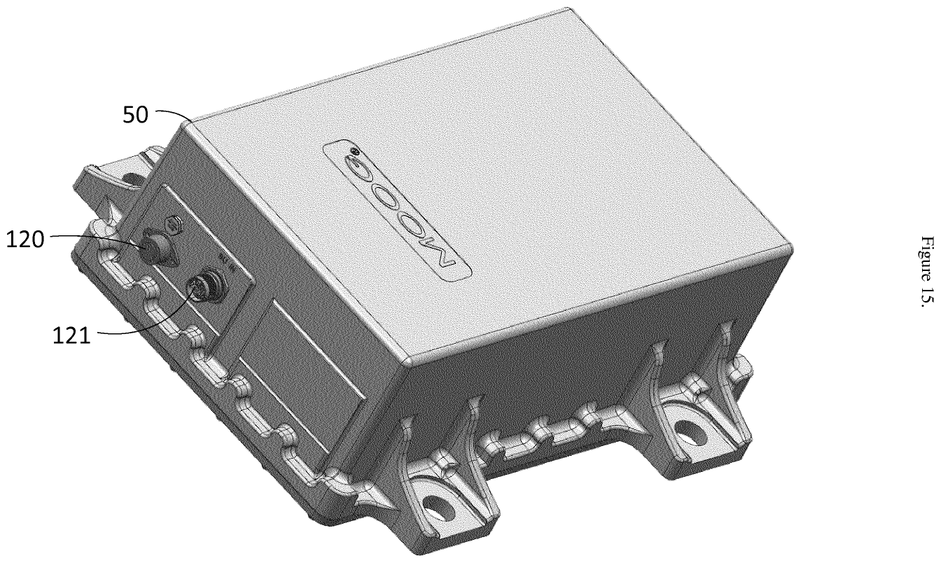

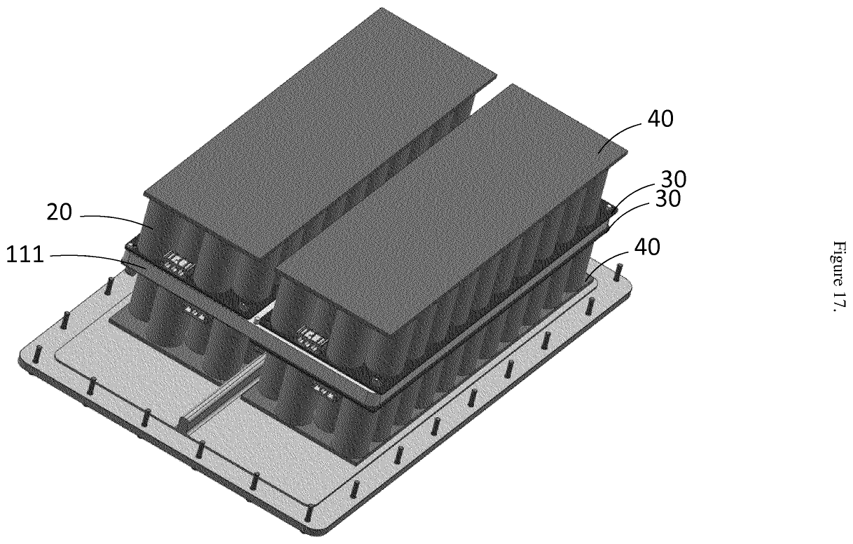

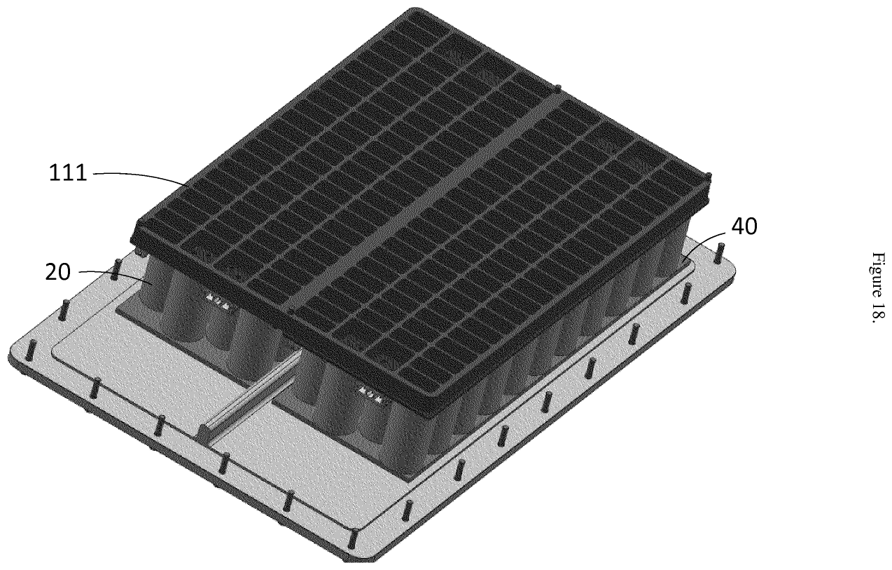

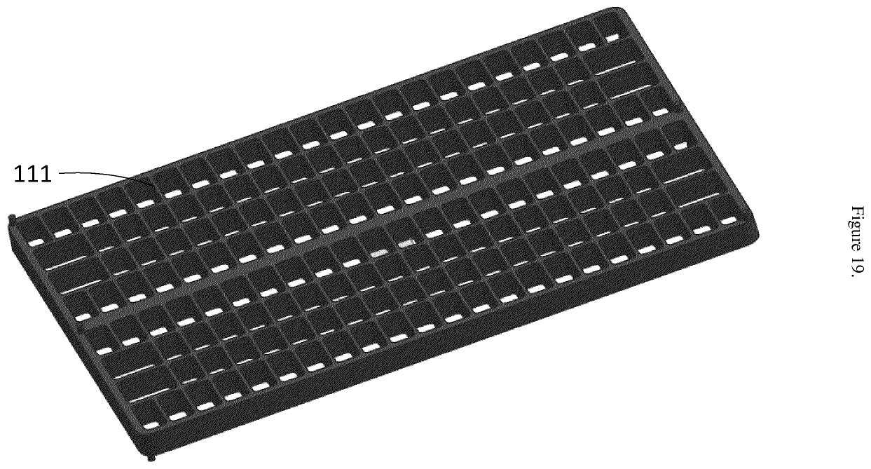

In an embodiment, alternating layers of energy storage devices 20, and PCBs 30 are orientated opposite to one another (or back to back), as shown in FIGS. 15-19, with two nearest layers effectively facing each other. Optionally, these opposing layers are separated by a spacer layer 111. In an embodiment, this spacer layer 111 is made of resiliently compressible material 40. This allows the electrical connections between the two PCBs to be very short and avoid losses from longer cables that connect the two PCBs. In embodiments where only two layers of capacitors are used, this configuration also allows for heat to dissipate from a top layer of capacitors via the top of the housing 50, from the bottom layer of capacitors via the bottom of the housing 50.

Optionally, the energy storage assembly 10 comprises a housing 50. In an embodiment, the housing 50 encloses the entirety of the energy storage device 20, PCB 30 and the resiliently compressible material 40. In an embodiment, the housing 50 is thermally insulated. In a further embodiment, the housing 50 is electrically insulated. It would be apparent to the skilled person, within the context of the invention that the housing 50 may be referred to as an ‘enclosure’, ‘case’, ‘casing’ or a ‘cabinet.’

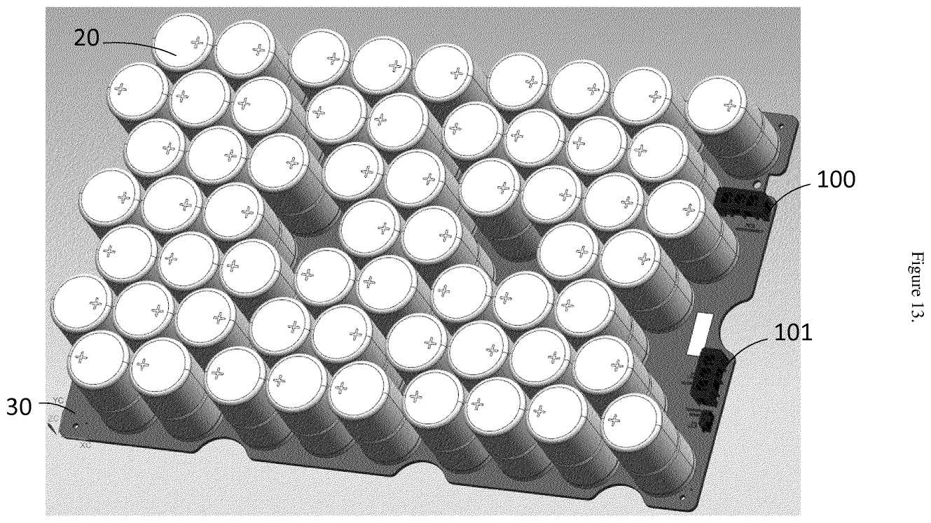

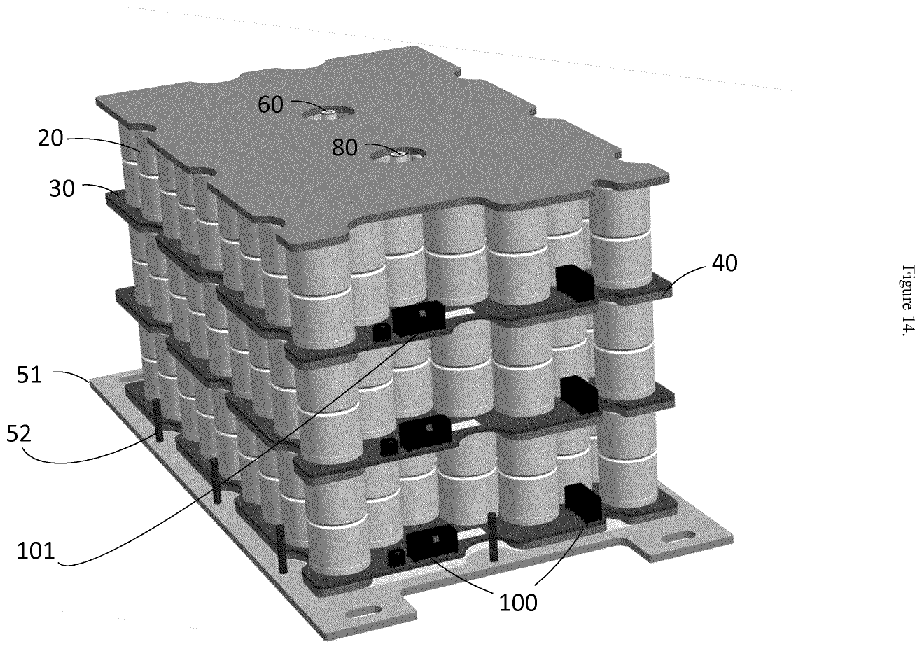

In an embodiment, the housing 50 has a cable outlet 99, allowing for electrical connections to be made with the energy storage assembly 10. As shown in FIGS. 13 and 14, each PCB has a series of electric connectors 100 which allow for the stacked layers to be electrically connected to each other via cables from one layer to another layer (not shown) and ultimately to other electronics located outside of the housing 50 via cable outlet 99. One of the connectors 101 corresponds with the hole for the cable outlet 99 so that once the housing is assembled a plug can be plugged in from the outside directly to the connector 101 on the PCB. In an alternative embodiment, the housing 50 has two outlets, fuse holder 120 and connection socket 121, as shown in FIG. 15.

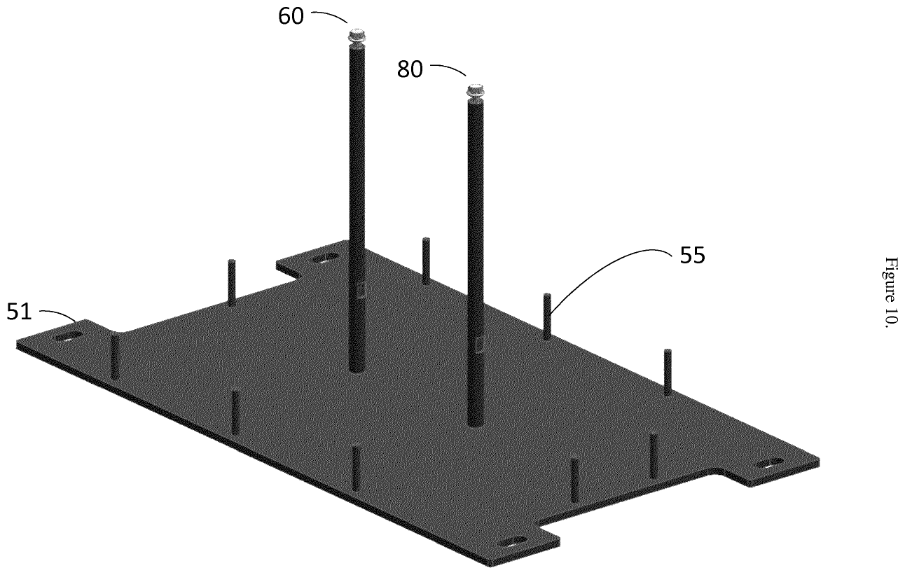

Optionally, the housing 50 is formed of a first part 51 and second part 52, which are brought together to enclose the energy storage device 20, PCB 30 and the resiliently compressible material 40. The skilled person would appreciate that the housing 50 could be made up of any number of component parts so as to partially or fully enclose the energy storage device 20, PCB 30 and the resiliently compressible material 40. In the embodiment shown in FIG. 10, a number of stud bolts 55 are pressed into the body of the first part 51 of the housing 50. These are used to engage the second part 52 of the housing 50.

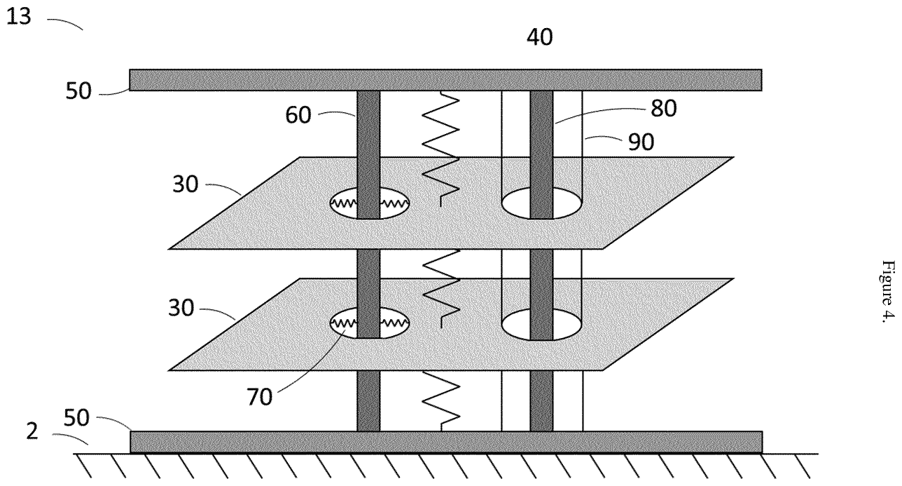

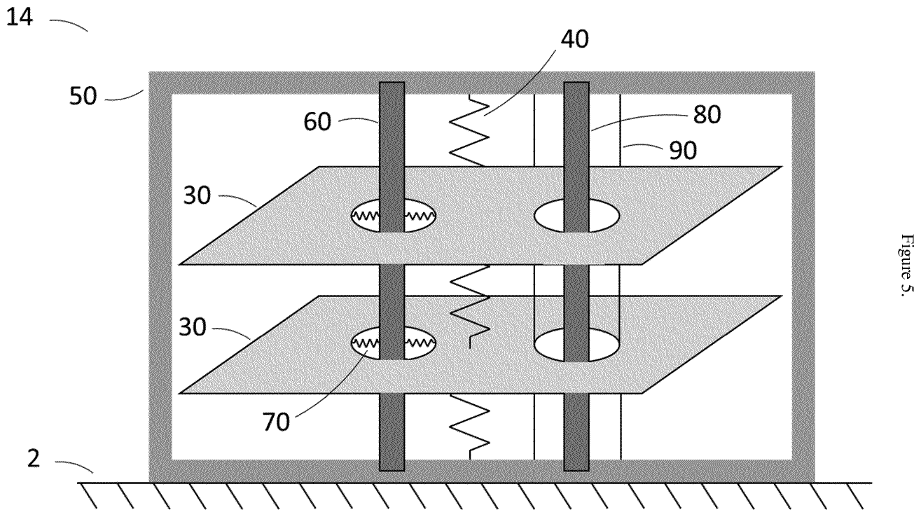

Optionally, the housing 50 comprises a first rod 60 which extends through the energy storage assembly 10, perpendicular to the layers of the energy storage assembly 10, as shown in FIGS. 4 and 5. In an embodiment, the opposite ends of this first rod 60 are attached to opposite points on the housing 50.

Optionally, the first rod 60 passes through pre-drilled holes in the PCB 30 layers of the energy storage assembly 10, with a resiliently compressible material 70 situated between the edge of the holes and the first rod 60.

Optionally, the housing 50 comprises a second rod 80, which extends through the energy storage assembly 10, perpendicular to the layers of the energy storage assembly 10. In an embodiment, the opposite ends of this first rod 60 are attached to opposite points on the housing 50. In a further embodiment, the second rod 80 passes through pre-drilled holes in the PCB 30 layers of the energy storage assembly 10.

In an embodiment, at least one of the first rod 60 and second rod 80 is attached to the first part 51 of the housing 50 and the other end is attached to the second part 52 of the housing 50. For this purpose in one embodiment additional stud bolts 56 are pressed into the body of the first part 51 of the housing 50 to accommodate the first rod 60 and the second rod 80. The first rod 60 and the second rod 80 are provided for this purpose with internal threads at one end of the first rod 60 and the second rod 80 so that the first rod 60 and the second rod 80 can be screwed onto the additional stud bolts 56 forming a fixation of the first rod 60 and the second rod 80 to the first part 51 of the housing 50.

In an embodiment, the rod 60 is separate from the housing 50, passing through clearance holes in the housing 50, and being secured with securing means. These securing means can be adjusted so as to vary the pre-compression force the housing applies to the energy storage assembly within. In an embodiment, the rod ends have an internal thread allowing a threaded bolt to travel so as to force the parts of the housing 50 together. In an alternative embodiment, the rod ends have an external thread allowing for the use of convention nuts.

Optionally, the housing 50 further comprises sleeves 90 around the portions of the second rod 80 which protrude from the PCB 30 layers of the energy storage assembly 10. In an embodiment, the sleeves are formed from a rigid material. In an alternative embodiment, the sleeves are formed from a resiliently compressible material. The skilled person would be aware that any number of rods 60, 80 can be provided, with any combination of sleeves 90 or resiliently compressible material 70.

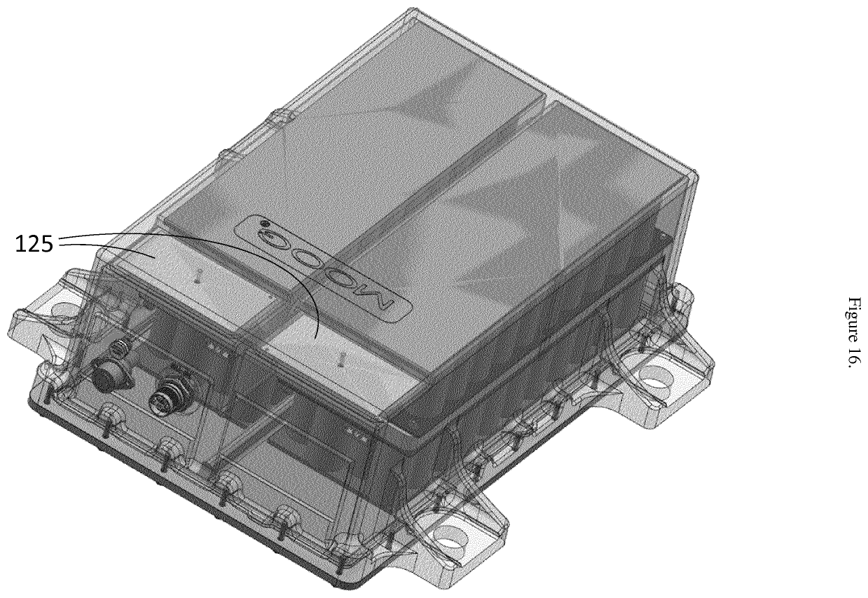

In an embodiment, the housing 50 also houses resistors 125, as shown in FIG. 16. Resistors 125 are used to heat the other components within the housing, and the case where the energy storage assembly 10 is used in a system comprising a generator or motor, the resistors 125 act as breaking resistors.

In an embodiment, the mounting surface 2 is the inner surface of a rotating body 1, having an axis of rotation 4, and a radial axis 3. In another embodiment, the mounting surface 2 is any inner surface within a rotating body which is tangential to the axis of rotation of the rotating body. In certain embodiments, the inner surface may be curved, in which case the energy storage assembly 10 is mounted such that the layers of the assembly 10 are tangent to a point on this inner surface. In a further embodiment, this point is the centre of the footprint of the energy storage assembly 10.

In a preferred embodiment, the mounting surface 2 is the inner surface of the hub of a wind turbine, the hub 1 having a radial axis 3 and an axis of rotation 4, such that the layers of the energy storage assembly 10 are perpendicular to the radial axis of the hub 3.

Alternatively, the layers of the energy storage assembly 10 are arranged parallel to the radial axis 3.

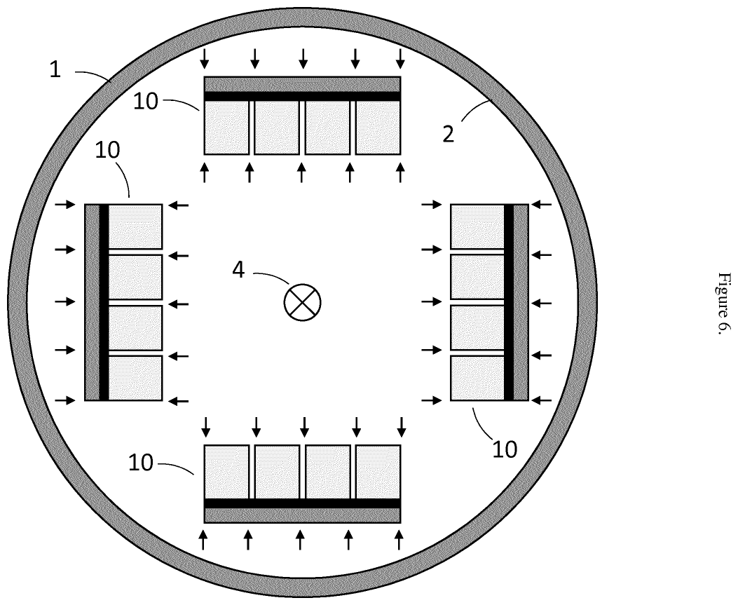

Optionally, additional energy storage assemblies 10 are radially disposed about the axis of rotation of the hub 3, as shown in FIG. 6.

During normal operation of a wind turbine, the hub 1 spins with the rotor blades. Accordingly, the direction in which gravity acts on the energy storage assembly 10 varies with the rotation of the hub 1 relative to Earth.

The centrifugal force experienced by the energy storage assembly 10 as it rotates with the hub 1 acts to compress the resiliently compressible material 40. Accordingly, the more delicate components of the energy storage assembly 10 (i.e. the energy storage device 20 and the PCB 30) are held in place, preventing the energy storage assembly 10 from experiencing motion relative to the hub 1 that could lead to damage to either the assembly 10 of the hub 1 itself. Simultaneously, the resiliently compressible material 40 within the energy storage assembly 10 absorbs a substantial portion of the centrifugal force that would otherwise compress the energy storage device 20 and the PCB 30 into the inner surface 2 of the hub 1.

In the embodiment of FIG. 4, the first rod 60 dampens any relative lateral shearing motions between the layers of the energy storage assembly 10. Second rod 80 and sleeves 90 act as further structural support.

In a further embodiment, the inner dimensions of the housing 50, which at least partially encloses the energy storage assembly 10 is such that when the housing 50 is sealed around the energy storage assembly 10, the resiliently flexible material 40 of the energy storage assembly 10 is compressed to a pre-defined degree, such that a pre-defined force is exerted on the other components of the energy storage assembly 10 (i.e. the energy storage device 20).

In a preferred embodiment, the resiliently compressible material 40 is stressed such that this force is set to twice the force of gravity and acts to compress the energy storage assembly 10 in the direction of the inner surface 2 of the hub 1. Therefore, when the hub is stationary (i.e. without the effect of a centrifugal force), the force on the components of the energy storage assembly 10 is between 1 g (when the energy storage assembly 10 is upside down relative to Earth) and 3 g (in the opposite case). Accordingly, when the hub 1 rotates and the centrifugal force comes into effect, the energy storage devices 20 of the energy storage assembly 10 experience a magnitude of force independent of gravity, (i.e. always higher than 1 g) and do not oscillate between −1 g and +1 g as in case of no pre-compression.

Therefore, there is provided an energy storage assembly 10 comprising a first layer, the first layer comprises an energy storage device 20 situated on a mounting surface 2, and a resiliently compressible material 40 situated between the energy storage device 20 and the mounting surface 2.

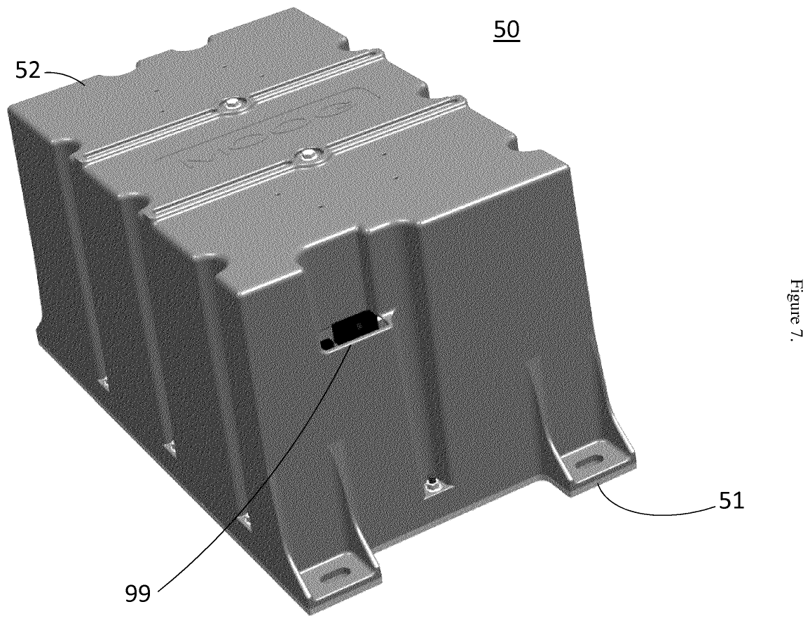

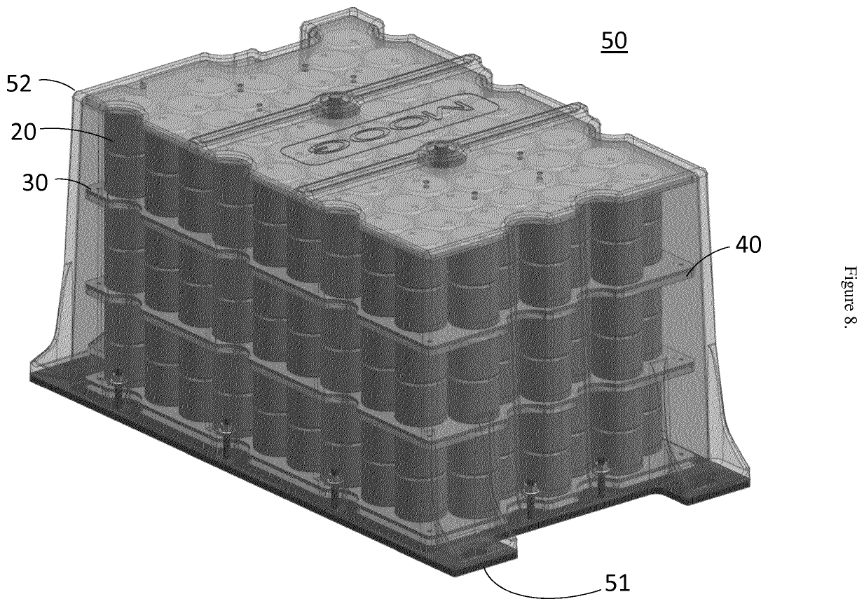

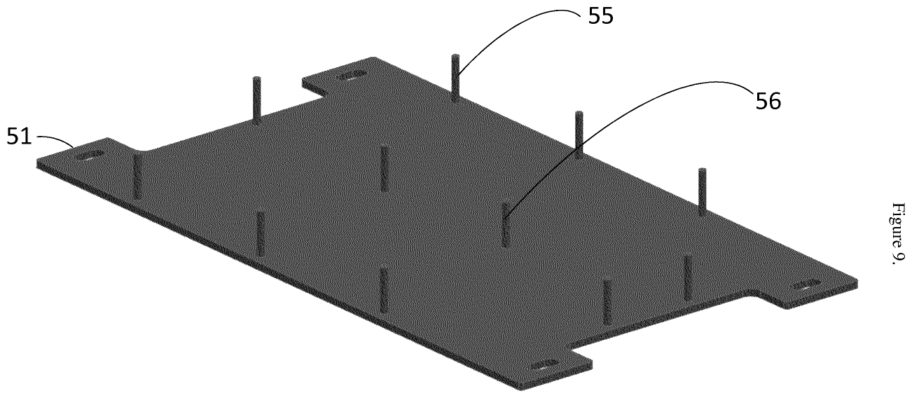

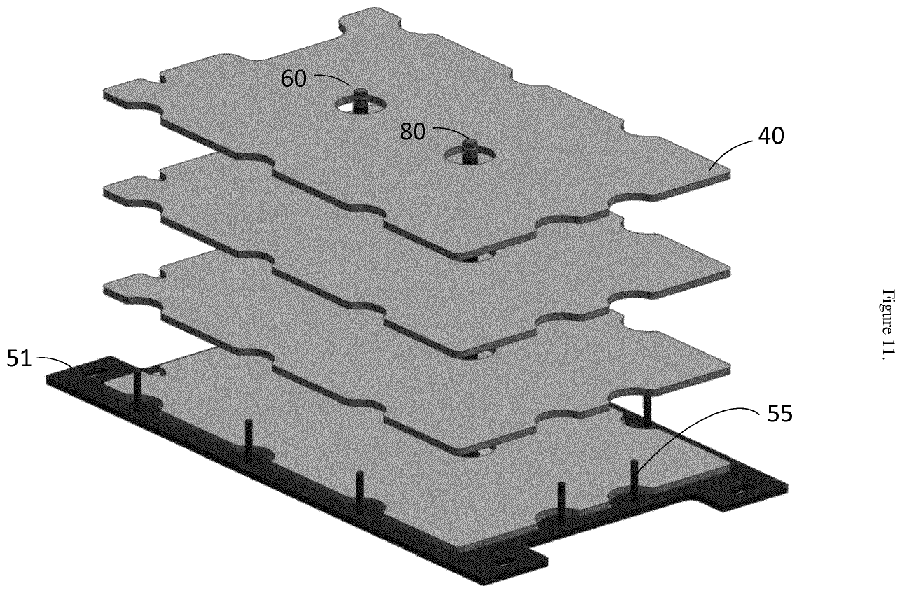

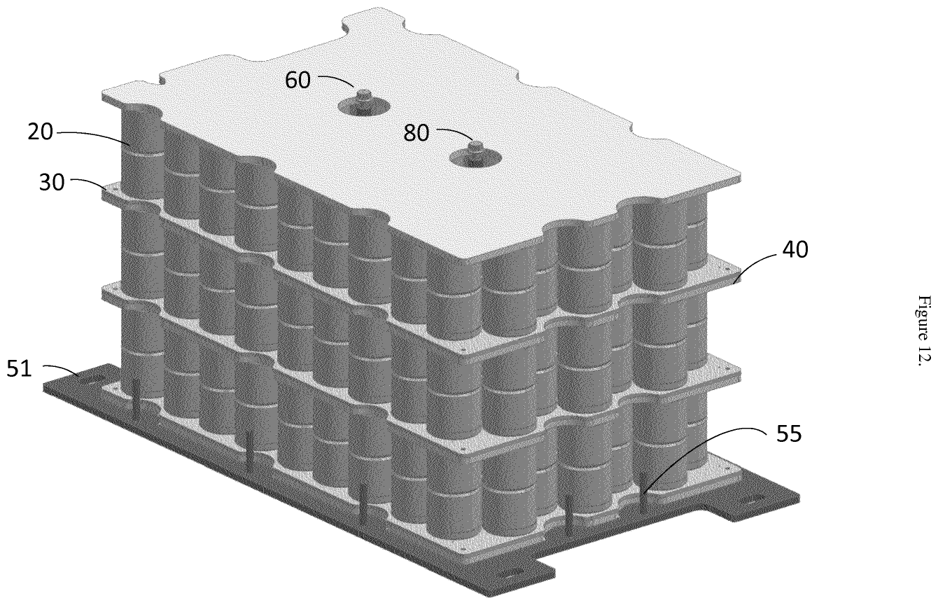

FIGS. 7-14 show a first embodiment of an energy storage assembly 10 in various stages of assembly.

FIGS. 15-19 show an alternative embodiment of an energy storage assembly 10 in various stages of assembly.

1. An energy storage assembly, the energy storage assembly comprising a first layer, wherein the first layer comprises;
an energy storage device situated on a mounting surface, and
a resiliently compressible material situated between the energy storage device and the mounting surface.

2. The energy assembly of claim 1, wherein the first layer further comprises a printed circuit board, wherein the energy storage device is mounted on the printed circuit board, and the printed circuit board is in contact to the resiliently compressible material.

3. The energy storage assembly of claim 2, wherein the printed circuit board is contacted to the resiliently compressible material by one of compression forces alone, a mechanical fixing, or chemical adhesive.

4. The energy storage assembly of claim 1, wherein the first layer further comprises a second resiliently compressible material such that the energy storage device is between the first and second resiliently compressible material.

5. The energy storage assembly of claim 1, wherein the energy storage device comprises a capacitor.

6. The energy storage assembly of claim 5, wherein the energy storage device comprises a bank of capacitors.

7. The energy storage assembly of claim 6, wherein the capacitors of the capacitor bank are connected in series.

8. The energy storage assembly of claim 1, wherein the resiliently compressible material comprises is one of a sheet of foam rubber or silicone.

9. The energy storage assembly of claim 1, wherein the resiliently compressible material comprises is one or more mechanical springs.

10. The energy storage assembly of claim 1, further comprising a second layer, wherein the second layer comprises an energy storage device and a resiliently compressible material, and the second layer is stacked on top of the first layer, such that the resiliently compressible material of the second layer is situated between the energy storage device of the second layer and the energy storage device of the first layer.

11. The energy storage assembly of claim 1, further comprising a second layer, wherein the second layer is stacked on top of the first layer and the second layer is inverted relative to the first layer.

12. The energy storage assembly of any of claim 11, wherein the layers are separated by a spacer layer.

13. The energy storage assembly of claim 11, wherein the second layer is otherwise identical to the first layer.

14. The energy storage assembly of claim 10, wherein the energy storage assembly comprises three layers.

15. The energy storage assembly of claim 1, wherein the energy storage assembly is situated in a housing, whereby the housing is attached to the mounting surface.

16. The energy storage assembly of claim 15, wherein the housing acts to pre-compress the resiliently compressible material, securing the energy storage assembly in place within the housing.

17. The energy storage assembly of claim 16, wherein the dimensions of the housing and the energy storage assembly are chosen such that assembling the housing about the energy-storage assembly causes the pre-compression.

18. The wind turbine hub of claim 16, wherein the pre-compression alone results in a force being exerted on the energy storage assembly in excess of twice the gravitational force acting on the energy storage assembly.

19. The energy storage assembly of claim 15, further comprising a second layer and wherein the housing further comprises one or more rods extending through the energy storage assembly, perpendicular to the layers of the energy storage assembly.

20. The energy storage assembly of claim 19, wherein the opposite ends of the one or more rods are connected to opposite sides of the housing.

21. The energy storage assembly of claim 19, further comprising a second layer comprising an energy storage device, a printed circuit board and a resiliently compressible material, and wherein the one or more rods pass through corresponding holes in the printed circuit board of each layer of the energy storage assembly, with a resiliently compressible material suited between the edges of the one or more rods and the corresponding holes.

22. The energy storage assembly of claim 21, wherein the resiliently compressible material comprises one of foam rubber or silicone.

23. The energy storage assembly of claim 21, wherein the resiliently compressible material comprises one or more mechanical spring.

24. The energy storage assembly of claim 15, further comprising a second layer comprising an energy storage device, a printed circuit board and a resiliently compressible material, and wherein the housing further comprises sleeves around the portions of one or more of the rods which protrude from the printed circuit board of each layer of the energy storage assembly.

25. The energy storage assembly of claim 1, wherein the mounting surface is the inner surface of a rotating body.

26. The energy storage assembly of claim 25, further comprising one or more additional energy storage assembly radially disposed about the axis of rotation of the rotating body.

27. (canceled)

28. (canceled)

29. (canceled)
